(19) United States
(12) Patent Application Publication
(10) Pub. No.: US 2008/0201381 A1
(43) Pub. Date: Aug. 21, 2008

(54) METHOD AND SYSTEM FOR INCREASING DATA RELIABILITY USING SOURCE CHARACTERISTICS

(76) Inventors: Aditya Abhay Desai, Morrisville, NC (US); Mandar U. Jog, Cary, NC (US); James Charles Thorburn, Toronto (CA)

Correspondence Address: MOORE & VAN ALLEN, PLLC For IBM, P.O. Box 13706, Research Triangle Park, NC, 27709, US

(21) Appl. No.: 11/675,692

(22) Filed: Feb. 16, 2007

(51) Int. Cl. G06F 17/30

(52) U.S. Cl. 707/200; 707/E17.001

(57) ABSTRACT

A method for increasing reliability of data may include tagging data from a data source with an indication of reliability based on characteristics of the data source. The method may also include performing a predetermined action in response to the indication of reliability.

### BACKGROUND OF THE INVENTION

The present invention relates to reliability or integrity of data from a data source or the like, and more particularly to a method and system for increasing data reliability or integrity using source characteristics related to a reputation of the source.

Most configuration management data bases (CMDBs) or data base systems typically employ dataflow networks in which data is assembled from various disparate sources that may be unreliable for one reason or another. Once this data is persisted in the CMDB, the data's provenance is lost, and the data may be erroneously considered to be absolutely definitive and complete. However, the data may be accepted by the CMDB without any evaluation of the reputation of the various sources that contributed to the data record. In a typical deployment, source reliability information associated with such a data record is not available to the CMDB. This hinders or prevents proper evaluation of the data and effective acceptance or rejection of the data.

### BRIEF SUMMARY OF THE INVENTION

In accordance with an embodiment of the present invention, a method for increasing reliability and completeness of data may include tagging data from a data source with an indication of reliability based on characteristics of the data source. The method may also include performing a predetermined action in response to the indication of reliability.

In accordance with another embodiment of the present invention, a system for increasing reliability and completeness of data may include a processor to tag data from a data source with an indication of reliability based on characteristics of the data source. The system may also include a policy engine to apply a policy based on a confidence level associated with the data source and to perform a predetermined action in response to the indication of reliability.

In accordance with another embodiment of the present invention, a computer program product to increase reliability and completeness of data may include a computer usable medium having computer usable program code embodied therein. The computer usable medium may include computer usable program code configured to tag data from a data source with an indication of reliability based on characteristics of the data source. The computer useable medium may further include computer usable program code configured to perform a predetermined action in response to the indication of reliability.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a flow chart of an exemplary method for increasing data reliability or integrity using data source characteristics in accordance with an embodiment of the present invention.

FIG. 2 is an illustration of an example a data flow in a system for increasing reliability or integrity of data using source characteristics in accordance with an embodiment of the present invention.

FIG. 3 is a block diagram of an example of a system for increasing reliability or integrity of data using source characteristics in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

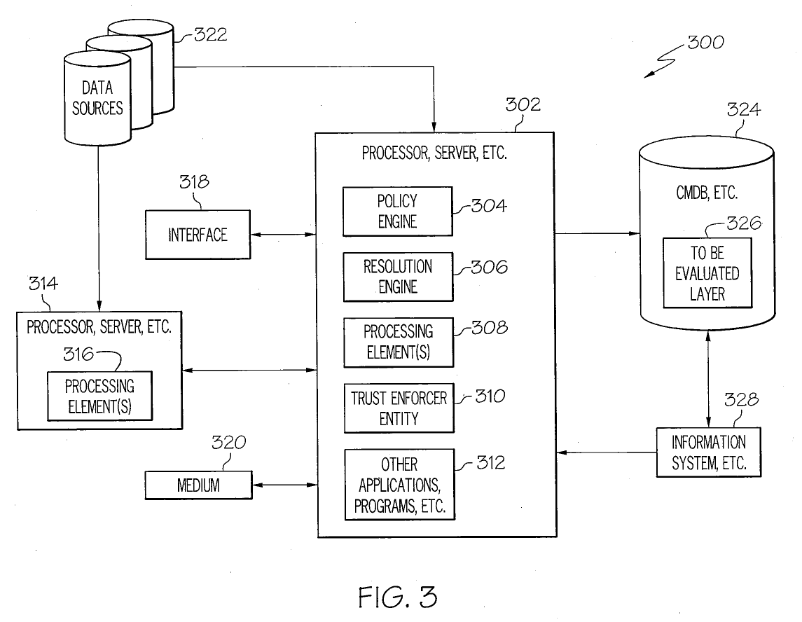

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium, such as for example medium 320 in FIG. 3, having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

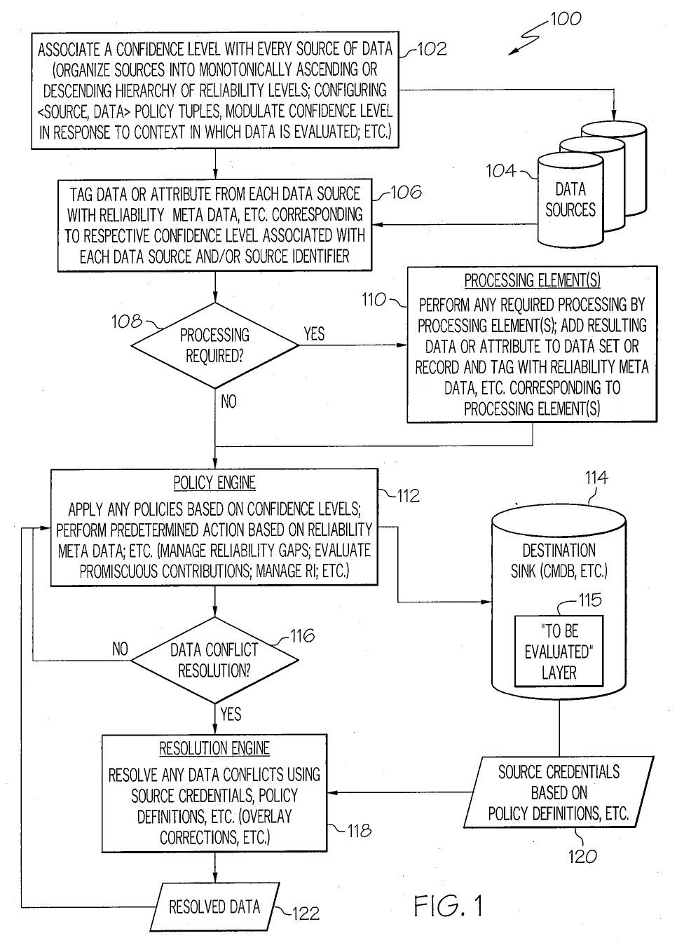

FIG. 1 is a flow chart of an exemplary method 100 for increasing data reliability or integrity using data source characteristics in accordance with an embodiment of the present invention. The data source characteristics may be related to source reputation for the integrity or reliability of the data from the source. In module or block 102, a confidence level may be associated with each data source 104. The data sources 104 may be part of or form a configuration management data base (CMDB) or other system. One example of assigning or associating a confidence level may be to organize the sources or a listing of the possible sources into a monotonically ascending or descending hierarchy of reliability levels based on the integrity or reliability of the data from each source. Reliability may be derived from characteristics of the source, such as source reputation for historically providing reliable data, type or class of entity or source providing the data, geographic location of the source, origination of the source, custodianship of the source, for example, business unit from which the data may be coming, or other characteristics of a source that may be worthy of consideration relative to reliability and integrity of data from the source.

Another example of a technique for assigning or associating a confidence level with each source may be to configure <source, data> policy tuples or sets of related values for the source and associated data or attributes from the source and a policy or rule for determining the confidence factor or level to be associated with the policy tuple. The confidence factor may be modulated or adjusted according to the context in which the data may be evaluated. For example, in the case of a source wherein data may be refreshed at twenty-four intervals, the data obtained immediately following an update may be more reliable compared to data just prior to the update. Accordingly, the confidence level may be adjusted over the twenty-four hour interval to compensate for the possible differences in reliability or integrity of the data.

In block or module 106, data or attributes from each data source 104 may be tagged with a source identifier or an indication of reliability or integrity based on characteristics of the respective data source 104 from which the data came. In accordance with an embodiment of the present invention, the data may be tagged with reliability meta data corresponding to a confidence level associated with the data source 104 from which the data originated or a data source identifier. Such reliability may be assessed on a container to container level—that is, the reliability of data in one container (e.g. a Table in a relational database) in the data source 104 from the perspective of one container in a destination sink 114 or CMDB. A source that has five containers that may feed the destination sink 114 or CMDB could have different reliability settings for each container. Accordingly, in an embodiment of the present invention, tagging could result in a source-container tag being used. The reliability of any source-containers may be determined through the same manner or method as described herein.

In block or module 108, a determination may be made if any processing of any of the data may be required. If processing is required, the method 100 may advance to block or processing element 110. Any processing may be performed in processing element or elements 110. An example of a processing element may be a JavaScript method or similar entity that may pull data from one or more data sources and then may perform a mathematical or some other computation on the data to construct a data element, attribute or a result. Any resulting data element or attribute from the processing element 110 may be added to the data set or record in the data pipeline. JavaScript is a trademark of Sun Microsystems in the United States, other countries or both.

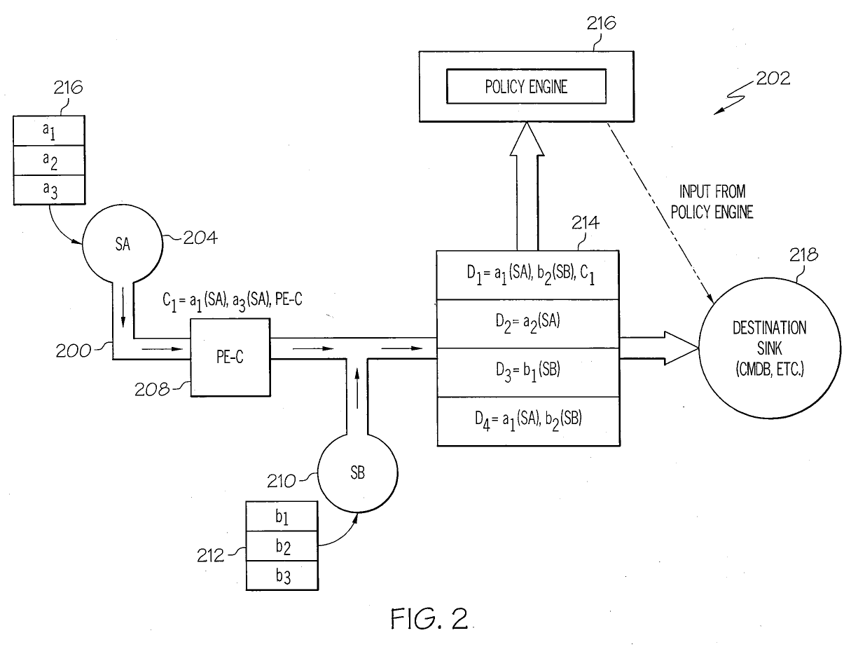

The resulting data or attribute from the processing element 110 may be tagged with an identifier or the process element 110 or reliability meta data or similar confidence factor corresponding to the reliability or reputation of the processing element 110. An example of tagging or adding a confidence attribute or factor corresponding to the processing element, or an identity of the processing element, to the data record or flow is described in the example of FIG. 2.

If no processing is required in block 108 or after the processing in the processing element 110 or elements, the method 100 may advance to block or module 112. Block 112 may be a policy engine to apply any policies based on confidence levels for each of the sources 104. A predetermined action may be performed based on the reliability meta data tagged to each portion of the data set or data record and any established policies. An example of a policy may be to perform a certain operation or follow a predefined protocol based on a predefined condition being met or existing. Examples of predetermined actions may include but are not necessarily limited to writing the data directly into a destination sink 114 in response to the indication of reliability or confidence level being a first predetermined level; writing the data into a “to be evaluated” layer 115 or other data base or memory location associated with the destination sink 114 in response to the indication or reliability or confidence level being a second predetermined level; rejecting the data in response to the indication of reliability or confidence level being a third predetermined level; or some other action in response to a further predetermined confidence level. The destination sink 114 may be a CMDB or other data base, data base system or other entity.

In accordance with another embodiment of the invention, a current value of the data or data record may be read from the destination sink 114 or policy engine 112 to determine if the data or data record is a new (additional or replacement data), an update, or some other classification. Examples of possible trust levels or confidence levels and associated predetermined action that may require knowledge of the type of data are illustrated in Table 1:

TABLE 1

| TRUST/CONFIDENCE LEVEL | PREDETERMINED ACTION |
|---|---|
| 0 | Reject Always |
| 1 | Accept new through scrutiny |
| 2 | Accept new or updates through |
| | scrutiny |
| 3 | Accept new to destination; accept |
| | updates through scrutiny |
| 4 | Accept new and updates |
| 5 | (4) + delete. (Complete control) |

The above set of confidence levels represents a sample set of confidence factors that can be associated with a source. To elaborate on the above sample set, in the first row of Table 1 any data coming from a source with confidence level 0 is to always be rejected. In the second row of Table 1, any new data coming from a source with confidence level 1 can be accepted after scrutiny while updates and deletes are rejected. In the third row, any new data and updates coming from a source with confidence level 2 will be accepted after scrutiny while deletes will be rejected. In the fourth row, any new data from a source with confidence level 3 is accepted as is, updates are accepted after scrutiny, and deletes are rejected. In the fifth row of Table 1, any new data and updates from a source with confidence level 4 are accepted as is, and any deletes are rejected. In the sixth row, any new data, updates and deletes from a source with confidence level 5 are accepted as is (full confidence). Complete control with a trust or confidence level of 5 may means that records or data found in the source that are not found in the CMDB will be added. Records found in the source that are already in the CMDB will be updated with any and all attributes recorded in the source. Records not found in the source that are found in the CMDB will be deleted.

The policy engine 112 or other element of a system, such as system 300 of FIG. 3, may be adapted to manage reliability gaps, accept promiscuous contributions, prevent entry of erroneous data and manage acceptance of referential integrity keys from multiple data sources. Reliability gaps in CMDB or other data base systems may be managed through granting data provenance-based rights. Data provenance may involve tagging data with information or meta data about its origins, such as from what database or database system the data is from, what entity maintains the data, how is the data maintained, how often is the data updated, or other information about the data's origin. Accordingly, rights may be granted with respect to a set of data relative to its data provenance.

A database may perform the task of enforcing referential integrity for data keys in its various tables. A CMDB is a special kind of database, in that its data is derived out of information from disparate sources. However the onus of enforcing referential integrity still lies on the CMDB just like any other database. In order to provide a reliable view of the data with referential integrity, the CMDB needs to resolve data conflicts in data obtained from different sources. Accepting promiscuous contributions or accepting data from multiple overlapping non-definitive sources in a CMDB or other system may be managed using limited data provenance-based rights. Entry of erroneous data from a believed reliable source may also be substantially prevented or avoided by data-provenance rights. Additionally, data corrections may be made by overlaying data from a generally reliable source.

As an example, consider a large source of data about an information technology (IT) environment that has 100 different tables relevant to a CMDB. Most of tables may be populated through some automated mechanism which is considered reliable. Some of the tables may be populated manually. Some of the tables may be populated through an unreliable mechanism, and some of the tables may be hardly populated at all. Accordingly, the source may be considered to have a set of reliability gaps. The source is generally a good source from a reliability perspective but has some very weak areas that are relevant to the CMDB. Accordingly, feeding directly into the CMDB would not be prudent, and certainly not without reliability tagging. By tagging the reliable tables in this source, the full benefit of the information contained in the reliable tables can be realized, without being victimized by the unreliable tables in the same source. This may be referred to herein as managing reliability gaps.

A CMDB's mandate is to describe an entire IT environment completely. Completeness is generally not achievable with any single definitive source. In part this is the nature of definitive sources; sources are definitive for what the sources know, but to deliver data quality the source must focus on a subset of the complete environment. To deliver completeness, the CMDB must therefore accept data from multiple sources, some of which may not be very reliable, but which are the only source for a given area. This challenge may derive from the type of device being tracked, the area of the business the systems are in, the part of the world where the systems are located, etc. The present invention may permit acceptance of promiscuous contributions. Less reliable data can be accepted into the CMDB and tagged as such, in order to deliver on completeness. The unreliable data may then be targeted for reinforcement through manual verification or the deployment of processes or systems that will deliver stronger or more reliable data as described herein.

Sources that are definitive are still not infallible. A small number of errors may be assumed to exist in even the best sources of data. Corrections may be accepted by the method and system of the present invention, so that the reliability of a source will not result in the overwriting of a correction made in a CMDB. The correction may act as an overlay until such time as the error is corrected in the definitive source. For example, assume data in a definitive source is recorded as “Jane Doe”. This may be corrected to “John Doe” in the CMDB. Without the Corrections Management feature of an embodiment of the present invention, the definitive source which still thinks the name is “Jane Doe” will overwrite any correction in the CMDB. In accordance with an embodiment of the present invention, a correction may be persisted and overlaid on top of the definitive source, so that when the source contains “Jane Doe”, the name is translated to “John Doe” and written into the CMDB. This also provides a way of feeding erroneous data back to the source or feeding back corrected data, should the source be accessible to such corrections. Growth of errors in a source will impact the source's reliability, so the feedback of errors sets up a virtuous cycle whereby a source gets more reliable and the CMDB enjoys the benefits of the increased reliability.

Acquisition of correct attribute values from external sources that fail referential integrity checks may also be managed by the present invention. Referential integrity is an important attribute of a database especially for an application developer. A CMDB may take data from multiple, flawed, non-controlled, external databases. The CMDB may deny entry of data to the database for data or data records that fail reference integrity checks or may add entries to List/Spec tables or other tables or files erroneously in order to maintain referential integrity. Accordingly, an embodiment of the present invention provides a framework in which the reference integrity of records or data from external sources with internal keyword lists and entity type specification tables can be managed.

Referring back to the example illustrated in Table 1, for the reliability setting or confidence level with a corresponding predetermined action identified as “Accept Updates through Scrutiny”, what is indicated here may be a process whereby attribute values that fail referential integrity checks may be routed through an “Information Management Zone”, in which these non-standard attributes are rejected, added to the list of acceptable values, or mapped to an existing acceptable value (as defined in the parent List or Specification table). The Information Management Zone is a virtual space where these unvalidated records and attributes may reside before and during the scrutiny. Where a source is external to the CMDB and the CMDB is alleged to be complete and definitive, the Information Management Zone may be called or created where data that arises out of reliability gaps, promiscuous contribution and corrections can be managed, in accordance with an embodiment of the present invention. The Information Management Zone may be the same as or similar to the “To be Evaluated” Layer 115 in FIG. 1. The Information Management Zone may be part of the CMDB or may be a separate element.

In block or module 116, a determination may be made if a conflict in data needs to be resolved. If no conflict needs to be resolved, the method 100 may return to block 112 and predetermined actions relative to the data or data record may be performed based on the reliability meta data as previously described. If data conflict resolution is needed in block 116, the method 100 may advance to block or module 118. Block or module 118 may be a resolution engine. The resolution engine 118 may resolve any data conflicts using source credentials, policy definitions or other techniques 120. For example data from a generally reliable source or sources may be overlaid to resolve conflicts and make corrections to the data. The resolved data 122 may then be returned to the policy engine 112 and the method 100 may proceed as previously described. Source credentials may involve confidence factors or trust/confidence levels similar to that previously described with reference to Table 1.

FIG. 2 is an illustration of an example a data flow 200 in a system 202 for increasing reliability or integrity of data using source characteristics in accordance with an embodiment of the present invention. Similar to that previously described, the source characteristics may be related to a level or reliability or integrity of the data, attributes or record from the source. A reliability tag may be derived from the source characteristics. A source identifier or reliability tag may then be associated with the data at the attribute or value level when the attribute or value enters the data flow 200 or is modified by a processing element during the data flow 200.

A source SA 204 may contribute attributes a₁, a₂ and a₃ 206 to the dataflow 200. A source identifier associated with the source SA 204 may be associated with each attribute 206, e.g., a₁(SA), a₂(SA), a₃(SA).

The system 202 may include a processing element (PE-C) 208 for processing or performing some operation on the data or record from the source SA 204 or on selected data or attributes in the data flow 200. When the processing element 208 processes the data or record, the processing element 208 may add a result or attribute C₁ to the record or data flow 200. The result or attribute C₁ may be tagged with a (virtual) source identifier of PE-C to identify the result or attribute as originating form the processing element 208. The source identifier may be or may correspond to a confidence or reliability indication or factor associated with the processing element 208 to indicate a reliability or integrity of the result or attribute C₁ from the processing element 208. Additionally the processing element 208 may also tag C₁ with the source identifier of SA 204 if the processing element 208 uses any of the attributes or data 206 (a₁, a₂ or a₃) from the source SA 204 to construct the value for attribute C₁. The granularity of the tag added may also include the precise source attributes (values) that were used to arrive at the net value of C₁. For example, if C₁ derives its value from attributes a₁ and a₃, the identifiers associated with C₁ will be: [a₁(SA), a₃(SA), PE-C].

The system 202 may include a second source SB 210. The second source SB 210 may add attributes 212 b1, b2, and b3 to the data flow 200. Each of attributes 212 may be tagged with a source identifier that may correspond to a reliability or confidence level or factor associated with the second source 210.

The system 202 may also include a trust enforcer entity 214 to evaluate the reliability of the data or attributes in the data flow 200. At the Trust enforcer entity 214, the individual attributes or data may appear as shown in the trust enforcer entity 214 in FIG. 2. This information including source identifiers is now available to a policy engine 216 to enforce reliability policy. Based on the reputation of the sources 206 and 210, the reliability or trust enforcer 314 may assign a confidence factor to this data record. The policy engine 216 may then choose to accept the record into a destination sink 218, accept individual attributes in the record, queue the record or individual attributes for scrutiny, reject attributes or reject the record based on the reputation of individual sources that contributed to this record or perform some other action. The destination sink 218 may be a CMDB or other system.

The policy engine 216 may also use source reputation to determine if active probes are required for confirmation. A probe may be any data sensing element that determines the current value of a data field. A probe may be as simple as a Java Database Connectivity (JDBC) or a Structured Query Language (SQL) query into a database. The probe may be referred to as an active probe because the probe may actively initiates a transaction to confirm the value of a certain piece of data rather than rely on available information to determine the authoritative value of data (passive determination).

The present invention may also permit the delivery of the database system or CMDB completeness in addition to reliability. By performance of the features or functions previously described, the present invention may provide that the data accepted by the CMDB or other database system is substantially complete, as well as reliable.

FIG. 3 is a block diagram of an example of a system 300 for increasing reliability or integrity of data using source characteristics in accordance with an embodiment of the present invention. The method 100 of FIG. 1 may be embodied in the system 300. A data flow similar to the data flow 200 illustrated in FIG. 2 may also be embodied in the system 300. The system 300 may include a processor 302, server or similar computing device. A policy engine 304 may be operable on the processor 302. The policy engine may be similar to policy engine 112 of FIG. 1 or policy engine 216 of FIG. 2 and may perform similar functions as previously described.

A resolution engine 306, one or more processing elements 308 and a trust enforcer may also be operable on the processor 302. The resolution engine 306 may be similar to the resolution engine 118 of FIG. 1 and may perform similar functions. The processing element 308 may be similar to processing element 208 and may perform similar operations to processing element 208, as previously described. In another embodiment of the present invention, the processing elements 208 may be operable on another processor, such as processor 314 in FIG. 3. In a further embodiment of the present invention processing elements 316 in addition to processing elements 308 may be operable on the processor 316.

The trust enforcer entity 310 may be similar to the trust enforcer entity 214 of FIG. 2 and may perform substantially the same functions as described with respect to trust enforcer 214. Other application or programs 312 may also be operable on the processor 302.

An interface 318 may be associated with the processor 320 to control operation of the processor 302. The interface 318 may include but is not necessarily limited to a keyboard, a computer pointing device, a monitor, an output devices or the like. A medium 320 may also be associated with the processor 302. The medium 320 may be similar to that previously described and embody the method 100 which may be loaded onto the processor 302 for performance of the method 100.

The processor 302 and associated components as described above may access a plurality of data sources 322 for transferring any data or attributes with increased fidelity or reliability from the data sources 318 to a destination sink or CMBD 324 similar to that previously described with respect to the method 100 of FIG. 1 and the system 200 FIG. 2. A “to be evaluated” layer 326 or similar data base location or memory location may be associated with destination sink 324 or CMDB. Similar to that previously described, data or attributes in the data flow or record may be entered into the “to be evaluated” layer 326 based on a confidence or reliability factor or level associated with a source from which the data or attribute originated. The data may then be evaluated by applying predefined policies or policy definitions, source credentials or the like to determine whether the data or attribute is reliable and can be entered or is unreliable and should be rejected.

An information system 328 or other system for accessing data may be associated with the CMDB 324 and the processor 302. The CMDB 324 may store information or data regarding the configuration of the information system 328.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for increasing reliability and completeness of data, comprising:
tagging data from a data source with a indication of reliability based on characteristics of the data source; and
performing a predetermined action in response to the indication of reliability.

2. The method of claim 1, wherein tagging the data comprises tagging the data with reliability meta data corresponding to a confidence level associated with the data source.

3. The method of claim 2, further comprising deriving the confidence level associated with the data source from at least one of a source reputation, a type of source, a class of source, a geographic location of the data source, an origination of the data source, and custodianship of the data source.

4. The method of claim 1, wherein the predetermined action comprises one of:
writing the data directly into a data base in response to the indication of reliability being a first predetermined level;
writing the data into a to be evaluated layer in response to the indication of reliability being a second predetermined level; and
rejecting the data in response to the indication of reliability being a third predetermined level.

5. The method of claim 4, wherein writing the data directly into the data base comprises writing the data directly into a configuration management data base system; and wherein writing the data into the to be evaluated layer comprises writing the data into a to be evaluated layer associated with the configuration management data base system.

6. The method of claim 1, further comprising tagging a result from a processing element with a reliability indication associated with the processing element.

7. The method of claim 6, wherein tagging the result from the processing element comprises tagging the result with reliability meta data corresponding to the processing element.

8. The method of claim 1, further comprising resolving any data conflicts using any source credentials and any policy definitions.

9. The method of claim 1, further comprising:
managing any reliability gaps in data from different data sources by granting data provenance-based rights;
accepting data from multiple overlapping non-definitive data sources using data provenance-based rights;
preventing entry of erroneous data from a reliable source; and
managing acquisition of correct attribute values from an external source that fails referential integrity checks.

10. The method of claim 1, further comprising associating a confidence level with each source of data of a plurality of data sources.

11. The method of claim 10, wherein associating a confidence level comprises organizing the plurality of data sources into one of a monotonically ascending hierarchy of reliability levels and a monotonically descending hierarchy of reliability levels.

12. The method of claim 10, wherein associating a confidence level comprises configuring <source, data> policy tuples and modulating the confidence level in response to a context in which the data is being evaluated.

13. A system for increasing reliability and completeness of data, comprising:
a processor to tag data from a data source with a indication of reliability based on characteristics of the data source; and
a policy engine to apply a policy based on a confidence level associated with the data source and to perform a predetermined action in response to the indication of reliability.

14. The system of claim 13, further comprising a resolution engine to resolve any conflicts between data using any source credentials and any policy definitions.

15. The system of claim 13, further comprising:
a configuration management data base; and
a module to perform one of:
accept the data directly into the configuration data base in response to a first predetermined confidence level associated with the data,
accept the data into a to be evaluated layer associated with the configuration management data base in response to a second predetermined confidence level associated with the data; and
reject the data in response to a third predetermined confidence level associated with the data.

16. The system of claim 13, further comprising a trust enforcer to evaluate a reliability of data in a data flow.

17. A computer program product for increasing reliability and completeness of data, the computer program product comprising:
a computer usable medium having computer usable program code embodied therein, the computer usable medium comprising:
computer usable program code configured to tag data from a data source with a indication of reliability based on characteristics of the data source; and
computer usable program code configured to perform a predetermined action in response to the indication of reliability.

18. The computer program product of claim 17, wherein the computer usable medium further comprises computer usable program code configured to tag the data with reliability meta data corresponding to a confidence level associated with the data source.

19. The computer program product of claim 18, wherein the computer usable medium further comprises computer usable program code configured to apply any policies based on the confidence level.

20. The computer program product of claim 17, wherein the computer usable medium further comprises computer usable program code configured to tag a result from a processing element with a reliability indication associated with the processing element.
